(19) United States
(12) Patent Application Publication
(10) Pub. No.: US 2022/0028376 A1
(43) Pub. Date: Jan. 27, 2022

(54) METHOD FOR SEMANTIC RECOGNITION, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Yufang WU, Beijing (CN); Qin QU, Beijing (CN); Qibo WANG, Beijing (CN); Chengjian MAN, Beijing (CN); Qiguang ZANG, Beijing (CN); Xiaoyin FU, Beijing (CN)

(73) Assignee: BEIJING BAIDU NETCOM SCIENCE TECHNOLOGY CO., LTD., Beijing (CN)

(21) Appl. No.: 17/450,714

(22) Filed: Oct. 13, 2021

(30) Foreign Application Priority Data
Nov. 18, 2020 (CN) 202011294260.6

(51) Int. Cl. G10L 15/18; G10L 15/06; G10L 15/02; G10L 15/16; G10L 15/22

(52) U.S. Cl. CPC G10L 15/1815; G10L 15/063; G10L 15/02; G06N 3/02; G10L 15/22; G10L 2015/027; G10L 15/16

(57) ABSTRACT

The disclosure discloses a method for semantic recognition, an electronic device, and a storage medium. The detailed solution includes: obtaining a speech recognition result of a speech to be processed, in which the speech recognition result includes a newly added recognition result fragment and a historical recognition result fragment; obtaining a semantic vector of each historical object in the historical recognition result fragment, and obtaining a semantic vector of each newly added object by inputting the semantic vector of each historical object and each newly added object in the newly added recognition result fragment into a streaming semantic coding layer; and obtaining a semantic recognition result of the speech by inputting the semantic vector of each historical object and the semantic vector of each newly added object into a streaming semantic vector fusion layer and a semantic understanding multi-task layer sequentially arranged.

### CROSS REFERENCE TO RELATED APPLICATION

This application is based on and claims priority to Chinese Patent Application No. 202011294260.6, filed on Nov. 18, 2020, the entire content of which is hereby incorporated by reference.

### FIELD

The disclosure relates to a field of artificial intelligence technologies and further to a field of deep learning and natural language processing technologies, and more particularly relate to a method for semantic recognition, an electronic device, and a storage medium.

### BACKGROUND

With development of artificial intelligence technologies, human-machine speech interaction has made great progress. As an important link in a field of natural language processing technologies, semantic recognition is widely used in a human-machine speech interaction system, such as an intelligent conversation system and an intelligent question-answering system.

### SUMMARY

The disclosure provides a method for semantic recognition, an electronic device, and a storage medium.

According to a first aspect of the disclosure, a method for semantic recognition is provided. The method includes: obtaining a speech recognition result of a speech to be processed, in which the speech recognition result includes a newly added recognition result fragment and a historical recognition result fragment, and the newly added recognition result fragment is a recognition result fragment corresponding to a newly added speech fragment in the speech; obtaining a semantic vector of each historical object in the historical recognition result fragment, and obtaining a semantic vector of each newly added object by inputting the semantic vector of each historical object and each newly added object in the newly added recognition result fragment into a streaming semantic coding layer; and obtaining a semantic recognition result of the speech by inputting the semantic vector of each historical object and the semantic vector of each newly added object into a streaming semantic vector fusion layer and a semantic understanding multi-task layer sequentially arranged.

According to a second aspect of the disclosure, an electronic device is provided. The electronic device includes at least one processor and a memory. The memory is communicatively coupled to the at least one processor. The memory is configured to store instructions executable by the at least one processor. When the instructions are executed by the at least one processor, the at least one processor is configured to: obtain a speech recognition result of a speech to be processed, wherein the speech recognition result comprises a newly added recognition result fragment and a historical recognition result fragment, and the newly added recognition result fragment is a recognition result fragment corresponding to a newly added speech fragment in the speech; obtain a semantic vector of each historical object in the historical recognition result fragment, and to obtain a semantic vector of each newly added object by inputting the semantic vector of each historical object and each newly added object in the newly added recognition result fragment into a streaming semantic coding layer; and obtain a semantic recognition result of the speech by inputting the semantic vector of each historical object and the semantic vector of each newly added object into a streaming semantic vector fusion layer and a semantic understanding multi-task layer sequentially arranged.

According to a third aspect of the disclosure, a non-transitory computer readable storage medium having computer instructions stored thereon is provided. The computer instructions are configured to cause a computer to execute the above method for semantic recognition. The method includes: obtaining a speech recognition result of a speech to be processed, wherein the speech recognition result comprises a newly added recognition result fragment and a historical recognition result fragment, and the newly added recognition result fragment is a recognition result fragment corresponding to a newly added speech fragment in the speech; obtaining a semantic vector of each historical object in the historical recognition result fragment, and obtaining a semantic vector of each newly added object by inputting the semantic vector of each historical object and each newly added object in the newly added recognition result fragment into a streaming semantic coding layer; and obtaining a semantic recognition result of the speech by inputting the semantic vector of each historical object and the semantic vector of each newly added object into a streaming semantic vector fusion layer and a semantic understanding multi-task layer sequentially arranged.

It should be understood that, content described in the Summary is not intended to identify key or important features of embodiments of the disclosure, but not used to limit the scope of the disclosure. Other features of the disclosure will become apparent from the following description.

### BRIEF DESCRIPTION OF THE DRAWINGS

The accompanying drawings are used for better understanding the solution and do not constitute a limitation of the disclosure.

FIG. 1 is a flow chart illustrating a method for semantic recognition according to a first embodiment of the disclosure.

FIG. 2 is a flow chart illustrating a method for semantic recognition according to a second embodiment of the disclosure.

FIG. 3 is a flow chart illustrating a method for semantic recognition according to a third embodiment of the disclosure.

FIG. 4 is a block diagram illustrating an apparatus for semantic recognition according to embodiments of the disclosure.

FIG. 5 is a flow chart illustrating a method for semantic recognition according to a fourth embodiment of the disclosure.

FIG. 6 is a block diagram illustrating an apparatus for semantic recognition according to a fifth embodiment of the disclosure.

FIG. 7 is a block diagram an apparatus for semantic recognition according to a sixth embodiment of the disclosure.

FIG. 8 is a block diagram illustrating an electronic device capable of implementing a method for semantic recognition according to embodiments of the disclosure.

### DETAILED DESCRIPTION

Description will be made below to exemplary embodiments of the disclosure with reference to accompanying drawings, which includes various details of embodiments of the disclosure to facilitate understanding and should be regarded as merely examples. Therefore, it should be recognized by the skilled in the art that various changes and modifications may be made to the embodiments described herein without departing from the scope and spirit of the disclosure. Meanwhile, for clarity and conciseness, descriptions for well-known functions and structures are omitted in the following description.

It may be understood that, with development of artificial intelligence technologies, human-machine speech interaction has made great progress. As an important link in a field of natural language processing technologies, semantic recognition is widely used in a human-machine speech interaction system such as an intelligent conversation system and an intelligent question-answering system.

Presently, when semantic recognition is performed, a speech recognition result of a whole sentence of a user is obtained, and then semantic analysis is performed on the speech recognition result. In this way, the human-machine speech interaction system has a long response time, causing a low interaction efficiency of the human-machine speech interaction system and a poor user experience.

In order to shorten the response time of the human-machine interaction system, improve interaction efficiency and user experience, the disclosure provides a method for semantic recognition. In the method, a speech recognition result of a speech to be processed is obtained. The speech recognition result includes a newly added recognition result fragment and a historical recognition result fragment. The newly added recognition result fragment is a recognition result fragment corresponding to a newly added speech fragment in the speech to be processed. A semantic vector of each historical object in the historical recognition result fragment is obtained. A semantic vector of each newly added object is obtained by inputting the semantic vector of each historical object and each newly added object in the newly added recognition result fragment into a streaming semantic coding layer. A semantic recognition result of the speech to be processed is obtained by inputting the semantic vector of each historical object and the semantic vector of each newly added object into a streaming semantic vector fusion layer and a semantic understanding multi-task layer both sequentially arranged. In this way, real-time semantic recognition of speech of the user is implemented, the response time of the human-machine speech interaction system is shortened, the interaction efficiency is improved, and the user experience is improved.

Description will be made below to a method for semantic recognition, an apparatus for semantic recognition, an electronic device, and a non-transitory computer readable storage medium according to embodiments of the disclosure with reference to accompanying drawings.

In combination with FIG. 1, detailed description is made to a method for semantic recognition provided by the disclosure.

FIG. 1 is a flow chart illustrating a method for semantic recognition according to a first embodiment of the disclosure. It should be noted that, in some embodiments, an execution subject of the method for semantic recognition is an apparatus for semantic recognition. The apparatus for semantic recognition may be an electronic device or may be configured in the electronic device to perform real-time semantic recognition on the speech of the user, so as to shorten the response time of the human-machine speech interaction system and improve the interaction efficiency and the user experience.

The electronic device may be any static or mobile computing device capable of performing data processing. The mobile computing device may be such as a notebook computer, a smart phone or a wearable device. The static computing device may be such as a desktop computer or a server. The apparatus for semantic recognition may be an electronic device, an application installed in the electronic device for semantic recognition, or a web page or an application used by a manager or a developer of the application capable of implementing the semantic recognition for managing and maintaining the application, which is not limited by the disclosure.

As illustrated in FIG. 1, the method for semantic recognition may include the following blocks.

At block 101, a speech recognition result of a speech to be processed is obtained.

The speech recognition result includes a newly added recognition result fragment and a historical recognition result fragment. The newly added recognition result fragment is a recognition result fragment corresponding to a newly added speech fragment in the speech to be processed.

It should be noted that, the speech recognition result of the speech to be processed may be obtained by the apparatus for semantic recognition performing speech recognition on the speech to be processed, or may also be sent to the apparatus for semantic recognition by other electronic devices with a speech recognition function, or by a component with a speech recognition function in the electronic device where the apparatus for semantic recognition is located, which is not limited by this embodiment of the disclosure. Embodiments of the disclosure take that the apparatus for semantic recognition performs the speech recognition on the speech to be processed as an example.

It may be understood that, in embodiments of the disclosure, the apparatus for semantic recognition may obtain the speech of the user in real time while the user is speaking, and perform speech recognition to obtain the speech recognition result, and perform the semantic recognition in real time based on the speech recognition result.

For example, it is assumed that, the speech of the user is recognized by the apparatus for semantic recognition once every one second. When obtaining a speech fragment “uuuo xiang ting (which means “I want to listen . . . ” in Chinese)” within a first one second, the apparatus for semantic recognition may obtain a speech recognition result “uuuo xiang ting” corresponding to the speech fragment “uuuo xiang ting”, and perform the semantic recognition on the speech fragment “uuuo xiang ting” based on the speech recognition result. When obtaining a speech fragment “Zhang San (which represents a name “Zhang San” of a people in Chinese)” within a second one second, the apparatus for semantic recognition may obtain a speech recognition result “uuuo xiang ting Zhang San (which means “I want to listen to Zhang San” in Chinese)” corresponding to a speech fragment “uuuo xiang ting Zhang San”, and perform the semantic recognition on the speech fragment “uuuo xiang ting Zhang San” based on the speech recognition result. When obtaining a speech fragment “de ge (which means “ . . . 's song” in Chinese)” within a third one second, the apparatus for semantic recognition may obtain a speech recognition result “uuuo xiang ting Zhang San de ge (which means “I want to listen to Zhang San's song” in Chinese)” corresponding to a speech fragment “uuuo xiang ting Zhang San de ge”, and performed semantic recognition is on the speech fragment ““uuuo xiang ting Zhang San de ge” based on the speech recognition result. The above process is repeated until the semantic recognition is implemented on the speech of the whole sentence of the user.

In embodiments of the disclosure, for each speech recognition result, a recognition result fragment same as the previous speech recognition result is taken as the historical recognition result fragment, and a fragment newly added based on the previous speech recognition result, that is, a recognition result fragment corresponding to the newly added speech fragment compared with the previously obtained speech fragment, is taken as the newly added recognition result fragment.

Continuing with the above example, after obtaining the speech fragments “uuuo xiang ting” and “Zhang San”, the apparatus for semantic recognition may perform the semantic recognition may be on the speech fragment “uuuo xiang ting Zhang San”. At this time, the speech to be processed includes the speech fragment “uuuo xiang ting Zhang San”. Comparing with the previously obtained speech fragment “uuuo xiang ting”, the currently obtained speech fragment newly added “Zhang San”, thus, the newly added speech fragment in the speech to be processed is “Zhang San”. The speech recognition result of the speech to be processed includes the historical recognition result fragment “uuuo xiang ting” and the newly added recognition result fragment “Zhang San”.

After obtaining the user's speech fragments “uuuo xiang ting”, “Zhang San” and “de ge”, the apparatus for semantic recognition may perform the semantic recognition on the speech fragment “uuuo xiang ting Zhang San de ge”. At this time, the speech to be processed includes the speech fragment “uuuo xiang ting Zhang San de ge”. Comparing with the previously obtained speech fragment “uuuo xiang ting Zhang San”, the currently obtained speech fragment newly added “de ge”, thus, the newly added speech fragment in the speech to be processed is “de ge”. The speech recognition result of the speech to be processed includes the historical recognition result fragment “uuuo xiang ting Zhang San” and the newly added recognition result fragment “de ge”.

It should be noted that, the apparatus for semantic recognition may perform the semantic recognition on the speech fragment “uuuo xiang ting” after obtaining the speech fragment “uuuo xiang ting”. At this time, the speech to be processed includes the speech fragment “uuuo xiang ting”, and the newly added speech fragment in the speech to be processed is “uuuo xiang ting”. Since this is the first time that the apparatus for semantic recognition obtains the speech fragment, the speech recognition result of the speech to be processed includes the newly added recognition result fragment “uuuo xiang ting”, but without any historical recognition result fragment.

At block 102, a semantic vector of each historical object in the historical recognition result fragment is obtained, and a semantic vector of each newly added object is obtained by inputting the semantic vector of each historical object and each newly added object in the newly added recognition result fragment into a streaming semantic coding layer.

The historical object is a smallest unit in the historical recognition result fragment. The newly added object is a smallest unit in the newly added recognition result fragment. For example, when the historical recognition result fragment takes a word as a unit, respective historical objects in the historical recognition result fragment “uuuo xiang ting” include “uuuo (which means “I” in Chinese)”, “xiang (which means “want” in Chinese)”, “ting (which means “listen” in Chinese)”. When the newly added recognition result fragment takes a word as a unit, respective newly added objects in the newly added recognition result fragment “de ge” include “de (which means “ . . . 's” in Chinese)” and “ge (which means “song” in Chinese)”.

It may be understood that, the apparatus for semantic recognition in embodiments of the disclosure includes a semantic recognition model. The semantic recognition model includes a streaming semantic coding layer, a streaming semantic vector fusion layer and a semantic understanding multi-task layer all sequentially arranged.

The streaming semantic coding layer is configured to obtain the semantic vector of each historical object and a semantic vector of each newly added object.

In embodiments of the disclosure, after the speech recognition result of the speech to be processed is obtained for the first time, the semantic vector of each newly added object in the newly added recognition result fragment included in the speech recognition result obtained for the first time may be determined through the streaming semantic coding layer. After the speech recognition result of the speech to be processed is obtained for the second time, the semantic vector of each newly added object in the newly added recognition result fragment included in the speech recognition result obtained for the second time may be determined through the streaming semantic coding layer according to each newly added object in the newly added recognition result fragment included in the speech recognition result obtained for the second time and the semantic vector of each newly added object in the newly added recognition result fragment included in the speech recognition result obtained for the first time, i.e., the semantic vector of each historical object in the historical recognition result fragment included in the speech recognition result obtained for the second time. After the speech recognition result of the speech to be processed is obtained for the third time, the semantic vector of each newly added object in a newly added recognition result fragment included in the speech recognition result obtained for the third time may be determined through the streaming semantic coding layer according to each newly added object in the newly added recognition result fragment included in the speech recognition result obtained for the third time and the semantic vector of each newly added object in the newly added recognition result fragments included in the speech recognition results obtained for the first time and the second time, i.e., the semantic vector of each historical object in the historical recognition result fragment included in the speech recognition result obtained for the third time.

By such analogy, after the speech recognition result of the speech to be processed is obtained, the semantic vector of each newly added object in the newly added recognition result fragment currently obtained may be determined through the streaming semantic coding layer based on each newly added object in the newly added recognition result fragment currently obtained and the semantic vector of each newly added object previously obtained every time, i.e., the semantic vector of each historical object in the historical recognition result fragment currently obtained. The semantic vector of each newly added object currently obtained, together with the semantic vector of each newly added object previously obtained each time, is used as the semantic vector of each historical object in the historical recognition result fragment when the semantic vector of each newly added object in the newly added recognition result fragment is obtained next time. The semantic vector of each newly added object in the newly added recognition result fragment obtained next time are determined through the streaming semantic coding layer according to the semantic vector of each historical object in the historical recognition result fragment in combination with each newly added object in the newly added recognition result fragment obtained next time.

For example, continuing with the above example, after obtaining the speech recognition result of the speech to be processed “uuuo xiang ting”, the apparatus for semantic recognition may obtain semantic vectors of three newly added objects “uuuo”, “xiang”, “ting” though the streaming semantic coding layer based on these newly added objects in the newly added speech fragment included in the speech recognition result. After obtaining the speech recognition result of the speech to be processed “uuuo xiang ting Zhang San”, the apparatus for semantic recognition may obtain semantic vectors of two newly added objects “Zhang” and “San” (“Zhang” represents the last name and “San” represents the first name) through the streaming semantic coding layer based on the newly added objects “Zhang” and “San” in the newly added speech fragment included in the speech recognition result and the semantic vectors of the newly added objects “uuuo”, “xiang”, “ting” previously determined. After obtaining the speech recognition result of the speech to be processed “uuuo xiang ting Zhang San de ge”, the apparatus for semantic recognition may obtain semantic vectors of two newly added objects “de” and “ge” through the streaming semantic coding layer based on the newly added objects “de” and “ge” in the newly added speech fragment included in the speech recognition result and the semantic vectors of five newly added objects “uuuo”, “xiang”, “ting”, “Zhang” and “San” previously determined.

In embodiments of the disclosure, when the semantic vector of each newly added object is obtained through the streaming semantic coding layer based on the semantic vector of each historical object in the historical recognition result fragment and each newly added object in the newly added recognition result fragment, the semantic vector of each historical object and each newly added object in the newly added recognition result fragment may be input into the streaming semantic coding layer, and an output of the streaming semantic coding layer is the semantic vector of each newly added object.

It should be noted that, when obtaining the semantic vector of each newly added object in the newly added recognition result fragment, in a case that there are multiple newly added objects in the newly added recognition result fragment, the semantic vector of each historical object and a newly added object ranked first in the newly added recognition result fragment may be input into the streaming semantic coding layer to obtain a semantic vector of the newly added object ranked first in the newly added recognition result fragment. The semantic vector of each historical object, the semantic vector of the newly added object ranked first in the newly added recognition result fragment and a newly added object ranked second in the newly added recognition result fragment are input into the streaming semantic coding layer to obtain a semantic vector of the newly added object ranked second in the newly added recognition result fragment. Then the semantic vector of each historical object, the semantic vector of the newly added object ranked first, the semantic vector of the newly added object ranked second and a newly added object ranked third in the newly added recognition result fragment are input into the streaming semantic coding layer to obtain a semantic vector of the newly added object ranked third in the newly added recognition result fragment. And so on, until the semantic vectors of all newly added objects in the newly added recognition result fragments are obtained.

It should be noted that, the ranking of objects in embodiments of the disclosure is arranged in an order of obtained times. For example, the historical recognition result fragment is “uuuo xiang ting”. Since the user says “uuuo” first, then “xiang” and then “ting” when speaking, the ranking for obtaining these historical objects “uuuo”, “xiang” and “ting” by the apparatus for semantic recognition is first “uuuo”, then “xiang” and then “ting”, accordingly. In this way, a ranking order of these historical objects is “uuuo” at the top, “xiang” at the second, and “ting” at the third.

It should be noted that, when each newly added object is input into the streaming semantic coding layer, a specific input may be a splicing vector obtained by splicing an object vector and a position vector of the newly added object. The object vector of the newly added object is configured to describe a characteristic of the newly added object. The position vector of the newly added object is configured to describe a position of the newly added object in the speech to be processed, such as, the newly added object ranking first or second in the speech to be processed. The object vector and the position vector of the newly added object may be obtained in a way of obtaining a feature vector in the related art, which is not limited in the disclosure.

For example, continuing with the above example, when the apparatus for semantic recognition obtains the semantic vectors of two newly added objects “Zhang” and “San” in the newly added recognition result fragment “Zhang San”, a semantic vector of the newly added object “Zhang” is obtained by inputting the semantic vectors of the historical objects “uuuo”, “xiang” and “ting” in the historical recognition result fragment, and a splicing vector of the newly added object “Zhang” into the streaming semantic coding layer. A semantic vector of the newly added object “San” is obtained by inputting the semantic vectors of the historical objects “uuuo”, “xiang” and “ting” in the historical recognition result fragment, the semantic vector of the newly added objects “Zhang”, and a splicing vector of the newly added object “San” into the streaming semantic coding layer. In this way, the semantic vectors of the two newly added objects “Zhang” and “San” in the newly added recognition result fragment may be obtained.

It may be understood that, when the semantic vector of each newly added object is obtained, in a case of employing a non-streaming semantic coding layer, every time obtaining the semantic vector of the newly added object, it is required to recalculated the semantic vector of each historical object, and then obtain the semantic vector of each newly added object based on the semantic vector of each historical object. Since the apparatus for semantic recognition performs real-time semantic recognition on speech of the user obtained in real time, the speech recognition result of the speech to be processed may be obtained multiple times during performing the semantic recognition on the speech of the whole sentence of the user. For example, the speech recognition result of the speech to be processed “uuuo xiang ting” is obtained for the first time, the speech recognition result of the speech to be processed “uuuo xiang ting Zhang San” is obtained for the second time, and the speech recognition result of the speech to be processed “uuuo xiang ting Zhang San de ge” is obtained for the third time. The semantic recognition is performed on the speech recognition result every time obtained based on the speech recognition result of the speech to be processed every time obtained. Every time the semantic recognition is performed, it is required to obtain the semantic vector of each newly added object in each newly added speech recognition result fragment in a speech recognition result of a current speech to be processed. Every time the speech recognition result of the speech to be processed is obtained, it is required to recalculate the semantic vector of each historical object, and then obtain the semantic vector of each newly added object in the newly added recognition result fragment based on the semantic vector of each historical object, which requires a large amount of calculation.

However, in embodiments of the disclosure, by employing the streaming semantic coding layer, the semantic vectors of all historical objects previously obtained may be reused to obtain the semantic vectors of each newly added object. There is no requirement, every time the speech recognition result of the speech is obtained, to recalculate the semantic vector of each historical object and then to obtain the semantic vector of each newly added object based on the semantic vector of each historical object. In this way, the amount of calculation is greatly reduced when obtaining the semantic vector of each newly added object and the speed of semantic recognition is improved. Further, the response time of the human-machine speech interaction is reduced, and the efficiency of speech interaction is improved.

For example, continuing with the above example, it is assumed that the whole speech to be said by the user is “uuuo xiang ting Zhang San de ge”, and there are three times for obtaining the speech recognition results of the speech to be processed during the semantic recognition on the whole speech. For the first time, the apparatus for semantic recognition obtains the speech recognition result of the speech to be processed “uuuo xiang ting”. The speech recognition result includes the newly added recognition result fragment “uuuo xiang ting”. The apparatus for semantic recognition may perform the semantic recognition on the speech to be processed “uuuo xiang ting” based on the speech recognition result of the speech to be processed “uuuo xiang ting”. For the second time, the apparatus for semantic recognition obtains the speech recognition result of the speech to be processed “uuuo xiang ting Zhang San”. The speech recognition result includes the historical recognition result fragment “uuuo xiang ting” and the newly added recognition result fragment “Zhang San”. The apparatus for semantic recognition may perform the semantic recognition on the speech to be processed “uuuo xiang ting Zhang San” based on the speech recognition result of the speech to be processed “uuuo xiang ting Zhang San”. For the third time, the apparatus for semantic recognition obtains the speech recognition result of the speech to be processed “uuuo xiang ting Zhang San de ge”. The speech recognition result includes the historical recognition result fragment “uuuo xiang ting Zhang San” and the newly added recognition result fragment “de ge”. The apparatus for semantic recognition may perform semantic recognition on the speech to be processed “uuuo xiang ting Zhang San de ge” based on the speech recognition result of the speech to be processed “uuuo xiang ting Zhang San de ge”.

Every time the semantic recognition is performed on the speech to be processed, it is required to obtain the semantic vector of each newly added object in the newly added recognition result fragment. When the non-streaming semantic coding layer is employed to obtain the semantic vector of each newly added object, during performing the semantic recognition on the speech to be processed “uuuo xiang ting”, it is required to calculate the semantic vector of the newly added object “uuuo”, and then calculate and obtain the semantic vector of the newly added object “xiang” based on the semantic vector of the newly added object “uuuo” and the newly added object “xiang”, and then calculate and obtain the semantic vector of the newly added object “ting” based on the semantic vectors of the newly added objects “uuuo”, “xiang”, and the newly added object “ting”.

During performing the semantic recognition on the speech to be processed “uuuo xiang ting Zhang San”, it is required to calculate the semantic vector of the historical object “uuuo” again, and then calculate the semantic vector of the historical object “xiang” again based on the semantic vector of the historical object “uuuo” and the historical object “xiang”, and then calculated the semantic vector of the historical object “ting” again based on the semantic vectors of the historical objects “uuuo” and “xiang” and the historical object “ting”. It is further required to calculate the semantic vector of the newly added object “Zhang” based on the semantic vectors of the historical objects “uuuo”, “xiang”, “ting”, and the newly added object “Zhang”, and then calculate the semantic vector of the newly added object “San” based on the semantic vectors of the historical objects “uuuo”, “xiang”, “ting”, the semantic vector of the newly added object “Zhang”, and the newly added object “San”.

During performing the semantic recognition on the speech to be processed “uuuo xiang ting Zhang San de ge”, it is required to calculate and obtain the semantic vectors of the historical objects “uuuo”, “xiang”, “ting”, “Zhang” and “San” again in a similar way as the above way, and then obtain the semantic vectors of the newly added objects “de” and “ge” based on the newly added objects “de” and “ge” respectively and the semantic vectors of each historical object.

It may be seen that, in a case that it is obtained by employing the non-streaming semantic coding layer when the semantic vector of each newly added object in the newly added recognition result fragment in the speech recognition result of the speech to be processed is obtained every time, the semantic vector of each historical object requires to be recalculated every time. The amount of calculation will be large in a case that the speech of the whole sentence of the user is long.

In embodiments of the disclosure, in the process of performing the semantic recognition on the speech to be processed “uuuo xiang ting Zhang San” by employing the streaming semantic coding layer, there is no requirement to recalculate the semantic vectors of the historical objects “uuuo”, “xiang”, “ting”, but the semantic vectors of the two newly added objects “Zhang” and “San” may be obtained directly based on the semantic vector of each historical object previously obtained. In the process of performing the semantic recognition on the speech to be processed “uuuo xiang ting Zhang San de ge”, there is no requirement to recalculate the semantic vectors of the historical objects “uuuo”, “xiang”, “ting”, “Zhang” and “San”, but the semantic vectors of the newly added objects “de” and “ge” are obtain directly based on the semantic vectors of the historical objects previously obtained. In this way, the amount of calculation may be reduced when obtaining the semantic vector of each newly added object, the speed of the semantic recognition is improved, the response time of the human-machine speech interaction is further reduced, and the speech interaction efficiency is improved.

At block 103, a semantic recognition result of the speech to be progressed is obtained by inputting the semantic vector of each historical object and the semantic vector of each newly added object into a streaming semantic vector fusion layer and a semantic understanding multi-task layer sequentially arranged.

The semantic understanding multi-task layer with a semantic recognition function is configured to obtain the semantic recognition result of the speech to be processed based on the semantic vector of each historical object and the semantic vector of each newly added object.

It may be understood that, the number of dimensions of respective semantic vectors may be different when the semantic recognition is performed based on the semantic vector of each historical object and the semantic vector of each newly added object. In this embodiment, the streaming semantic vector fusion layer is configured to unify the number of dimensions of respective semantic vectors, such that the semantic vector of each historical object and the semantic vector of each newly added object may be used to perform the semantic recognition by the semantic understanding multi-task layer. In addition, the streaming semantic vector fusion layer may fuse the semantic vector of each historical object and the semantic vector of each newly added object in time sequence to obtain a fusion semantic vector of each historical object and a fusion semantic vector of each newly added object. Then the semantic recognition result of the speech is obtained based on the fusion semantic vector of each historical object and the fusion semantic vector of each newly added object by employing the semantic understanding multi-task layer with the semantic recognition function.

In detail, the semantic vector of each historical object and the semantic vector of each newly added object are input into the streaming semantic vector fusion layer ranked in front of the semantic understanding multi-task layer, such that the number of dimension unification and fusing in time sequence for the semantic vectors of each historical object and each newly added object may be implemented. Then an output result of the streaming semantic vector fusion layer is input into the semantic understanding multi-task layer to obtain the semantic recognition result of the speech to be progressed.

It may be understood that, according to the method for semantic recognition provided by embodiments of the disclosure, the semantic recognition may be started while obtaining the speech of the user, instead of waiting until a complete speech of the user is obtained, therefore the response time of the human-machine speech interaction system is shortened and the interaction efficiency is improved. Due to employing the streaming semantic coding layer, when the semantic recognition is performed on the speech of the user, the semantic vectors of all historical objects having obtained previously may be reused to obtain the semantic vector of each newly added object. There is no requirement to recalculate and obtain the semantic vector of each historical object every time the speech recognition result of the speech to be processed is obtained, and then to obtain the semantic vector of each newly added object based on the semantic vector of each historical object. In this way, the amount of calculation may be greatly reduced when the semantic vector of each newly added object is obtained, and the speed of the semantic recognition is improved. The response time of human-machine speech interaction is further reduced, and the efficiency of speech interaction is improved.

With the method for semantic recognition provided by embodiments of the disclosure, the speech recognition result of the speech to be processed is obtained. The semantic vector of each historical object in the historical recognition result fragment is obtained. The semantic vector of each newly added object is obtained by inputting the semantic vector of each historical object and each newly added object in the newly added recognition result fragment into the streaming semantic coding layer. The semantic recognition result of the speech is obtained by inputting the semantic vector of each historical object and the semantic vector of each newly added object into the streaming semantic vector fusion layer and the semantic understanding multi-task layer sequentially arranged. In this way, real-time semantic recognition on the speech of the user is implemented, the response time of the human-machine speech interaction system is shortened, the interaction efficiency is improved, and the user experience is enhanced.

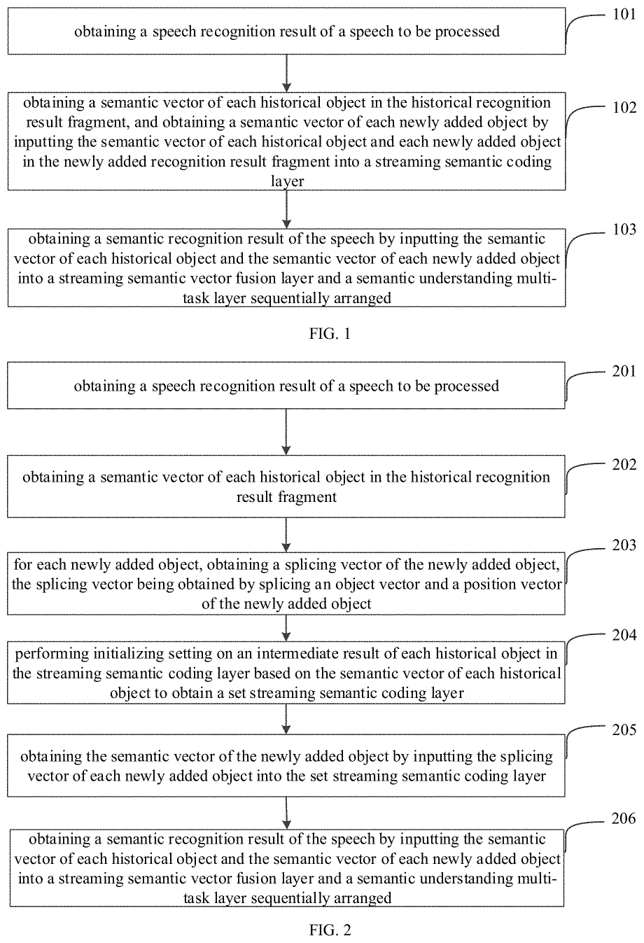

It may be known from the above analysis that, in embodiments of the disclosure, the semantic vector of each historical object and each newly added object in the newly added recognition result fragment may be input into the streaming semantic coding layer to obtain the semantic vector of each newly added object. With reference to FIG. 2, description will be further made below to the process of obtaining the semantic vector of each newly added object by employing the streaming semantic coding layer based on the semantic vector of each historical object and each newly added object in the newly added recognition result fragment in the method for semantic recognition provided by the disclosure.

FIG. 2 is a flow chart illustrating a method for semantic recognition according to a second embodiment of the disclosure. As illustrated in FIG. 2, the method may include the following blocks.

At block 201, a speech recognition result of a speech to be processed is obtained.

The speech recognition result includes a newly added recognition result fragment and a historical recognition result fragment. The newly added recognition result fragment is a recognition result fragment corresponding to a newly added speech fragment in the speech to be processed.

The detailed implementation process and principle of the action at block 201 may be referred to the description in the above embodiment, which is not elaborated here.

In an exemplary embodiment, the speech recognition result obtained by the apparatus for semantic recognition may be in a unit of a word. Accordingly, each historical object is each word in the historical recognition result fragment in the speech recognition result, and each newly added object is each word in the newly added recognition result fragment in the speech recognition result. The apparatus for semantic recognition may perform the semantic recognition on the speech to be processed based on the speech recognition result in the unit of the word.

It may be understood that, in some scenes, performing the semantic recognition on the speech to be processed based on the speech recognition result in the unit of the word may cause an inaccurate semantic recognition result. For example, in a far-field speech interaction, due to noise interference and signal attenuation, and a complex diversity of slots in a vertical domain, such as homophones, near-homophones, long-tail words, and user accent problems, a situation that the pronunciation is right and the word is wrong may be occurred in the speech recognition result. When the apparatus for semantic recognition further perform the semantic recognition based on the wrong speech recognition result, error accumulation may be caused, thereby appearing the inaccurate semantic recognition result. In addition, comparing with the speech recognition result in a unit of a syllable, the speech recognition result in the unit of the word has a higher probability for occurring errors, which may cause a decrease in the number of the semantic vectors of each historical object that have been obtained previously for reusing when the semantic vector of each newly added object is obtained by the streaming semantic coding layer.

In embodiments of the disclosure, the speech recognition result obtained by the apparatus for semantic recognition may also be in the unit of the syllable. Accordingly, each historical object is each syllable in the historical recognition result fragment in the speech recognition result, and each newly added object is each syllable in the newly added recognition result fragment in the speech recognition result. The apparatus for semantic recognition may perform the semantic recognition on the speech to be processed based on the speech recognition result in the unit of the syllable. In an embodiment, the speech recognition result of the speech to be processed may be obtained in the following way: inputting the speech to be processed into a syllable recognition model to obtain a syllable recognition result of the speech to be processed; taking the syllable recognition result as the speech recognition result of the speech to be processed.

The syllable recognition model may be any model that may be configured to recognize the syllable of the speech to be processed in the field of natural language processing, such as a convolutional neural network model, or a recursive neural network model, which is not limited in the disclosure.

For example, it is assumed that after the apparatus for semantic recognition obtains the speech to be processed for the first time, in a case that a recognition result fragment of the speech to be processed is “uuuo xiang ting” in the unit of the word, the speech to be processed is input into the syllable recognition model to obtain a syllable recognition result “uu_T0_uo_T3 x_T0_iang_T3 t_T0_ing_T1”. Then the syllable recognition result is taken as the speech recognition result of the speech to be processed.

After the apparatus for semantic recognition obtains the speech to be processed for the second time, in a case that the recognition result fragment of the speech to be processed is “uuuo xiang ting Zhang San” in the unit of the word, the speech to be processed is input into the syllable recognition model to obtain a syllable recognition result “uu_T0_uo_T3 x_T0_iang_T3 t_T0_ing_T1 zh_T0_ang_T1 s_T0_an_T1”. Then, the syllable recognition result may be taken as the speech recognition result of the speech to be processed. In the speech recognition result, the historical recognition result fragment is “uu_T0_uo_T3 x_T0_iang_T3 t_T0_ing_T1”, and the newly added recognition result fragment is “zh_T0_ang_T1 s_T0_an_T”. Then, the semantic recognition may be performed on the speech to be processed based on the speech recognition result of the speech to be processed.

After the speech to be processed is obtained by the apparatus for semantic recognition for the third time, in a case that a recognition result fragment of the speech is “uuuo xiang ting Zhang San de ge” in the unit of the word, the speech to be processed is input into the syllable recognition model to obtain a syllable recognition result “uu_T0_uo_T3 x_T0_iang_T3 t_T0_ing_T1 zh_T0_ang_T1 s_T0_an_T1 T38 g_T0_e_T1”. Then the syllable recognition result may be taken as the speech recognition result of the speech. In the speech recognition result, the historical recognition result fragment is “uu_T0_uo_T3 x_T0_iang_T3 t_T0_ing_T1 zh_T0_ang_T1 s_T0_an_T1”, and the newly added recognition result fragment is “T38 g_T0_e_T1”. Then, the semantic recognition may be performed on the speech to be processed based on the speech recognition result of the speech to be processed.

In embodiments of the disclosure, the apparatus for semantic recognition may obtain the speech recognition result in the unit of the syllable, and then perform the semantic recognition on the speech to be processed based on the speech recognition result in the unit of the syllable. On the one hand, the speech recognition result in the unit of the syllable does not have the situation that the pronunciation is right and the word is wrong, thereby improving the accuracy of the speech recognition result, reducing the error accumulation when the semantic recognition is performed based on the speech recognition result, enhancing an error tolerance of the semantic recognition model in the apparatus for semantic recognition to the error in the speech recognition result, and improving the accuracy of the semantic recognition result of the semantic recognition model in the apparatus for semantic recognition and robustness of the semantic recognition model. On the other hand, the speech recognition result in the unit of the syllable has less probability for occurring errors than the speech recognition result in the unit of the word, and the speech recognition result is more stable. Therefore, the number of the semantic vectors of each historical object that have been obtained previously for reusing when the semantic vector of each newly added object is obtained by the streaming semantic coding layer may be increased, thereby further reducing the amount of calculation and improving the speed of the semantic recognition.

At block 202, a semantic vector of each historical object in the historical recognition result fragment is obtained.

In detail, the apparatus for semantic recognition may directly obtain the semantic vector of each historical object that has been determined previously during performing the semantic recognition on the speech to be processed obtained each time. The detailed implementation process and principle of the above action at block 202 may be referred to the description in the above embodiments, which is not described in detail here.

At block 203, for each newly added object, a splicing vector of the newly added object is obtained. The splicing vector is obtained by splicing an object vector and a position vector of the newly added object.

The object vector of the newly added object is configured to describe a characteristic of the newly added object. The position vector of the newly added object is configured to describe a position of the newly added object in the speech to be processed, such as, the newly added object ranking first or second in the speech to be processed. The object vector and the position vector of the newly added object may be obtained in any way of obtaining a feature vector in the related art, which is not limited in the disclosure.

In an embodiment, for each newly added object, the object vector and the position vector of the newly added object are spliced to obtain the splicing vector of the newly added object.

At block 204, initializing setting is performed on an intermediate result of each historical object in the streaming semantic coding layer based on the semantic vector of each historical object to obtain a set streaming semantic coding layer.

At block 205, the semantic vector of the newly added object is obtained by inputting the splicing vector of each newly added object into the set streaming semantic coding layer.

In detail, after the semantic vector of each historical object is obtained, the semantic vector of each historical object may be determined as the intermediate result of the historical object in the streaming semantic coding layer. The initializing setting is performed on the intermediate result of each historical object in the streaming semantic coding layer to obtain the set streaming semantic coding layer. Then the splicing vector of each newly added object is input into the set streaming semantic coding layer to obtain the semantic vector of the newly added object.

Through the above process, the semantic vector of each newly added object is obtained by employing the streaming semantic coding layer based on the semantic vector of each historical object and the newly added object in the newly added recognition result fragment. The semantic vector of each newly added object may be obtained by reusing the semantic vector of each historical object that has been obtained previously. Therefore, there is no requirement, every time the speech recognition result of the speech is obtained, to recalculate and obtain the semantic vector of each historical object, and then to obtain the semantic vector of each newly added object based on the semantic vector of each historical object. In this way, the amount of calculation is greatly reduced when the semantic vector of each newly added object is obtained, and the speed of the semantic recognition is improved. The response time of the human-machine speech interaction is further reduced, and the speech interaction efficiency is improved.

At block 206, a semantic recognition result of the speech is obtained by inputting the semantic vector of each historical object and the semantic vector of each newly added object into a streaming semantic vector fusion layer and a semantic understanding multi-task layer sequentially arranged.

The detailed implementation process and principle of the action at block 206 may be referred to the detailed description for the above embodiments, which is not described in detail here.

It may be understood that, in embodiments of the disclosure, when obtaining the semantic vector of each newly added object of the newly added recognition result fragment in the speech recognition result of the speech to be progressed, for each newly added object, obtaining the currently newly added object is based on the semantic vector of each historical object ranked prior to the newly added object in the recognition result fragment of the speech to be processed, or based on the semantic vector of each historical object and the semantic vector of the newly added object ranked prior to the currently newly added object in the recognition result fragment of the speech to be processed. That is, in embodiments of the disclosure, obtaining the semantic vector of each newly added object by employing the streaming semantic coding layer may be based on all historical objects ranked prior to a current newly added object in the recognition result fragment of the speech to be processed, or all historical objects and the newly added objects ranked prior to the currently newly added object in the recognition result fragment of the speech to be processed, but not based on any newly added object ranked after the currently newly added object in the recognition result fragment of the speech to be processed. In this way, the semantic vector of each historical object that has been obtained previously may be reused, thereby achieving a purpose of reducing the amount of calculation when the semantic vector of the newly added object is obtained, shortening the response time of the human-machine speech interaction system and improving the interaction efficiency. To achieve the purpose, it is required that a structure of the streaming semantic coding layer is unidirectional, and a structure of the streaming semantic vector fusion layer also requires to unidirectional correspondingly.

In an embodiment, the streaming semantic coding layer may be implemented by a multi-layer coding layer of a transformer model widely used in the field of natural language processing, that is, the streaming semantic coding layer includes the multi-layer coding layer of the transformer model. A bidirectional network of the transformer model fuses information of front and back positions simultaneously. Therefore, it may be set that a coding layer of the transformer model includes a multi-head-attention mechanism with a mask. In this way, obtaining the semantic vector of each newly added object by the streaming semantic coding layer may depends on the historical objects ranked prior to the currently newly added object in the recognition result fragment of the speech to be processed, or the historical objects and newly added objects ranked prior to the currently newly added object in the recognition result fragment of the speech, and does not depend on the newly added object ranked after the currently newly added object in the recognition result fragment of the speech to be processed.

The number of the coding layers of the transformer model may be set as requirements. For example, the number of the coding layers may be set flexibly based on requirements of the human-machine speech interaction system on a response speed and the accuracy of the semantic recognition.

In an embodiment, the streaming semantic vector fusion layer may be a unidirectional LSTM (long short-term memory) layer. The LSTM is a time recurrent neural network which is a kind of recurrent neural network (RNN).

With setting the streaming semantic coding layer including the multi-layer coding layer of the transformer model, the coding layer including the multi-head-attention mechanism with the mask, and the streaming semantic vector fusion layer to be the unidirectional LSTM layer, performing the semantic recognition on the speech to be processed may depend on the historical object ranked prior to the currently newly added object in the recognition result fragment of the speech, or the historical objects and the newly added objects ranked prior to the currently newly added object in the recognition result fragment of the speech, and does not depend on the newly added object ranked after the currently newly added object in the recognition result fragment of the speech. In this way, when the semantic vector of each newly added object is obtained, the semantic vector of each historical object that has been obtained previously may be reused, thereby reducing the amount of calculation when the semantic vector of the newly added object is obtained, and shortening the response time of the human-machine speech interaction.

With the method for semantic recognition according to embodiments of the disclosure, after the speech recognition result of the speech to be processed is obtained, the semantic vector of each historical object in the historical recognition result fragment is obtained. For each newly added object, the splicing vector of the newly added object is obtained, and the splicing vector is obtained by splicing the object vector and the position vector of the newly added object. Initializing setting is performed on the intermediate result of each historical object in the streaming semantic coding layer based on the semantic vector of each historical object to obtain the set streaming semantic coding layer. The semantic vector of the newly added object is obtained by inputting the splicing vector of each newly added object into the set streaming semantic coding layer. The semantic recognition result of the speech is obtained by inputting the semantic vector of each historical object and the semantic vector of each newly added object into the streaming semantic vector fusion layer and the semantic understanding multi-task layer sequentially arranged. In this way, the real-time semantic recognition on the speech of the user is implemented, the response time of the human-machine speech interaction system is shortened, the interaction efficiency is improved, and the user experience is improved.

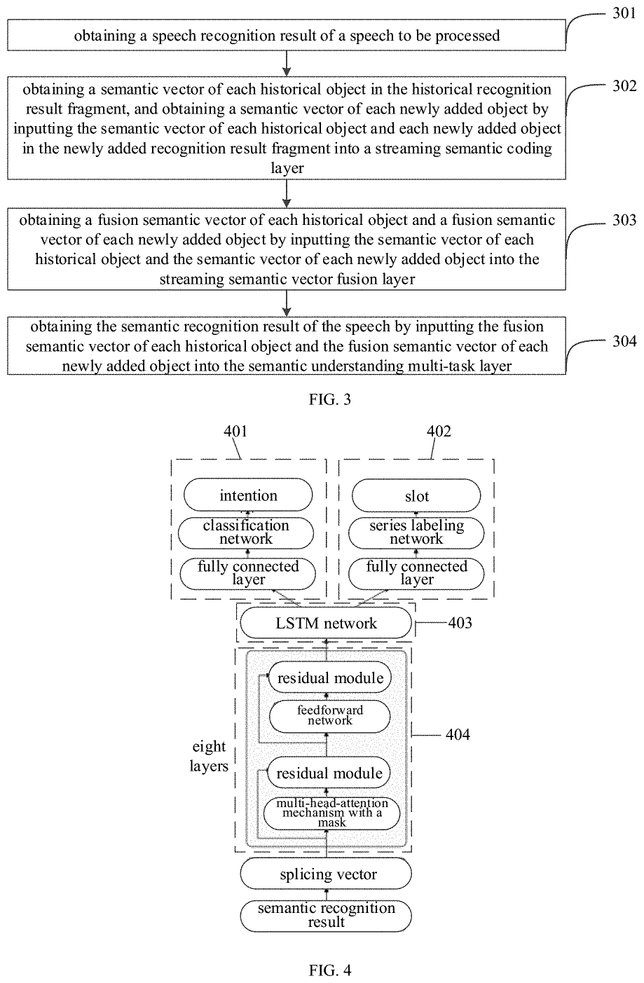

It may be known from the above analysis that, in embodiments of the disclosure, the semantic vector of each historical object and the semantic vector of each newly added object may be input into the streaming semantic vector fusion layer and the semantic understanding multi-task layer sequentially arranged to obtain the semantic recognition result of the speech to be processed. With reference to FIG. 3, description will be made blow to the process of obtaining the semantic recognition result to be processed based on the semantic vector of each historical object and the semantic vector of each newly added object in the method for semantic recognition provided by the disclosure.

FIG. 3 is a flow chart illustrating a method for semantic recognition according to a third embodiment of the disclosure. As illustrated in FIG. 3, the method may include the following blocks.

At block 301, a speech recognition result of a speech to be processed is obtained.

The speech recognition result includes a newly added recognition result fragment and a historical recognition result fragment. The newly added recognition result fragment is a recognition result fragment corresponding to a newly added speech fragment in the speech to be processed.

At block 302, a semantic vector of each historical object in the historical recognition result fragment is obtained, and a semantic vector of each newly added object is obtained by inputting the semantic vector of each historical object and each newly added object in the newly added recognition result fragment into a streaming semantic coding layer.

For the detailed implementation process and principle of the action at blocks 301-302, please refer to the description for the above embodiments, which is not elaborated here.

At block 303, a fusion semantic vector of each historical object and a fusion semantic vector of each newly added object are obtained by inputting the semantic vector of each historical object and the semantic vector of each newly added object into the streaming semantic vector fusion layer.

The fusion semantic vector of the newly added object is obtained by performing semantic vector fusion on the newly added object and one or more objects ranked prior to the newly added object.

At block 304, the semantic recognition result of the speech is obtained by inputting the fusion semantic vector of each historical object and the fusion semantic vector of each newly added object into the semantic understanding multi-task layer.

The semantic understanding multi-task layer has a semantic recognition function and is configured to obtain the semantic recognition result of the speech to be progressed based on the semantic vector of each historical object and the semantic vector of each newly added object.

It may be understood that, the number of dimensions of respective semantic vectors may be different when semantic recognition is performed based on the semantic vector of each historical object and the semantic vector of each newly added object. In this embodiment, the streaming semantic vector fusion layer is configured to unify the number of dimensions of respective semantic vectors, such that the semantic vector of each historical object and the semantic vector of each newly added object may be used to perform the semantic recognition by the semantic understanding multi-task layer. In addition, the streaming semantic vector fusion layer may fuse the semantic vector of each historical object and the semantic vector of each newly added object in time sequence to obtain a fusion semantic vector of each historical object and a fusion semantic vector of each newly added object. Then the semantic recognition result of the speech is obtained based on the fusion semantic vector of each historical object and the fusion semantic vector of each newly added object by employing the semantic understanding multi-task layer with the semantic recognition function.

In detail, the semantic vector of each historical object and the semantic vector of each newly added object are input into the streaming semantic vector fusion layer ranked in front of the semantic understanding multi-task layer, such that unifying the number of dimension and fusing in time sequence for the semantic vectors of each historical object and each newly added object may be implemented. Then an output result of the streaming semantic vector fusion layer is the fusion semantic vector of each historical object and the fusion semantic vector of each newly added object. The output result of the streaming semantic vector fusion layer is input into the semantic understanding multi-task layer to obtain the semantic recognition result of the speech to be progressed.

For each historical object, the streaming semantic vector fusion layer may be configured to perform semantic vector fusion on the semantic vector of the current historical object and the semantic vector of each historical object ranked prior to the current historical object in the recognition result segment of the speech to obtain the fusion semantic vector of the current historical object.

For each newly added object, the streaming semantic vector fusion layer may be configured to perform the semantic vector fusion on the semantic vector of the currently newly added object and the semantic vector of each object ranked prior to the currently newly added object in the recognition result segment of the speech to obtain the fusion semantic vector of the currently newly added object. The objects ranked prior to the currently newly added object may only include each historical object ranked prior to the currently newly added object, or may also include each historical objects ranked prior to the currently newly added object and one or more newly added objects ranked prior to the currently newly added object.

For example, it is assumed that the speech recognition result of the speech to be processed includes the historical recognition result fragment “uuuo xiang ting” and the newly added recognition result fragment “Zhang San”. The streaming semantic vector fusion layer may perform the semantic vector fusion on the respective semantic vectors of the historical objects “uuuo” and “xiang” to obtain a fusion semantic vector of the historical object “xiang”. The streaming semantic vector fusion layer may perform the semantic vector fusion on the respective semantic vectors of the historical objects “uuuo”, “xiang”, and “ting” to obtain a fusion semantic vector of the historical object “ting”. In addition, the streaming semantic vector fusion layer may perform the semantic vector fusion on the semantic vectors of the historical objects “uuuo”, “xiang”, and “ting” and the semantic vector of the newly added object “Zhang” to obtain a fusion semantic vector of the newly added object “Zhang”. The streaming semantic vector fusion layer may perform semantic vector fusion on the semantic vectors of the historical objects “uuuo”, “xiang”, and “ting” and the semantic vectors of the newly added objects “Zhang” and “San” to obtain a fusion semantic vector of the newly added object “San”.

When the semantic vector fusion is performed on multiple semantic vectors, multiple semantic vectors may be summed to obtain the fusion semantic vector.

With inputting the semantic vector of each historical object and the semantic vector of each newly added object into the streaming semantic vector fusion layer, unifying the number of dimension and fusing in time sequence for the semantic vector of each object are implemented, and then the semantic recognition result of the speech to be processed may be obtained based on the fusion semantic vector of each object subjected to semantic vector fusion through the semantic understanding multi-task layer.

In an embodiment, the semantic understanding multi-task layer may include an intention recognition branch and a slot recognition branch. Accordingly, the action at block 304 may be implemented in the manner illustrated in following action at blocks 304a-304c.

At block 304a, an intention recognition result of the speech to be progressed is obtained by inputting a fusion semantic vector of a first newly added object sorted last in respective newly added objects into the intention recognition branch.

The intention recognition is to determine what the user wants to do. For example, when the user asks a question to the human-machine speech interaction system, the human-machine speech interaction system are required to determine whether the question asked by the user is about weather, travel or information of a movie. The determining process is the process of intention recognition.

The intention recognition branch is used to recognize an intention of the speech to be processed. The intention recognition branch may be any structure that may realize intention recognition in the related art, which is not limited by the disclosure.

In detail, the fusion semantic vector of the first newly added object ranked last among the newly added objects may be input into the intention recognition branch to obtain the intention recognition result of the speech.

At block 304b, a slot recognition result of the speech to be progressed is obtained by inputting the fusion semantic vector of each historical object and the fusion semantic vector of each newly added object into the slot recognition branch.

Slot recognition is to extract a predetermined structured field from the speech of the user, so as to give a more accurate feedback to a subsequent processing flow.

The slot recognition branch is configured to recognize a slot of the speech. The slot recognition branch may employ any structure that may realize the slot recognition in the related art, which is not limited by the disclosure.

In detail, the fusion semantic vector of each historical object and the fusion semantic vector of each newly added object may be input into the slot recognition branch to obtain the slot recognition result of the speech to be progressed.

At block 304c, the semantic recognition result of the speech to be progressed is generated based on the intention recognition result and the slot recognition result.

In detail, after the intention recognition result and the slot recognition result of the speech to be progressed are obtained, the semantic recognition result of the speech to be progressed may be generated based on the intention recognition result and the slot recognition result.

Description will be further made below to the method for semantic recognition provided in the disclosure with reference to the block diagram illustrated in FIG. 4.

As illustrated in FIG. 4, the semantic recognition model may include a streaming semantic coding layer (illustrated in block 404), a streaming semantic vector fusion layer (illustrated in block 403), and a semantic understanding multi-task layer. The semantic understanding multi-task layer includes an intention recognition branch (illustrated in block 401) and a slot recognition branch (illustrated in block 402). The streaming semantic coding layer may be a multi-layer coding layer of a transformer model. The coding layer includes a multi-head-attention mechanism with a mask, and the number of the coding layers takes 8 layers as an example. The multi-layer coding layer of the transformer model also includes a residual module and a feedforward network. The streaming semantic vector fusion layer is a unidirectional LSTM (long short-term memory) layer. The intention recognition branch includes a fully connected layer and a classification network. The classification network may be a Softmax classification network. The slot recognition branch includes a fully connected layer and a sequence labeling network. The sequence labeling network may be a CRF (conditional random field) network.

As illustrated in FIG. 4, every time the semantic recognition is performed on the speech recognition result of the speech to be progressed, a splicing vector of each newly added object which is obtained by splicing an object vector and a position vector may be obtained, and the splicing vector may be input to the streaming semantic coding layer. Every time obtaining the speech recognition result of the speech, the streaming semantic coding layer may obtain a semantic vector of each newly added object based on the splicing vector of each newly added object and a semantic vector of each historical object that has been obtained previously. Then, the semantic vector of each historical object and the semantic vector of each newly added object may be input into the unidirectional LSTM layer for unifying the number of dimension and fusing in time sequence to obtain a fusion semantic vector of each historical object and a fusion semantic vector of each newly added object. The fusion semantic vector of each historical object and the fusion semantic vector of each newly added object output by the unidirectional LSTM layer may be input into the semantic understanding multi-task layer. A fusion semantic vector of a first newly added object ranked last among the newly added objects is input into the intention recognition branch, and then processed by the fully connected layer and the classification network, to output a classification with a highest probability as an intention recognition result. The fusion semantic vector of each historical object and the fusion semantic vector of each newly added object are input into the slot recognition branch, and processed by the fully connected layer and the sequence labeling network, to output a path with a highest score as a slot recognition result. In this way, the semantic recognition result of the speech to be progressed may be obtained based on the intention recognition result and the slot recognition result.

With setting the intention recognition branch and the slot recognition branch in the semantic understanding multi-task layer, the intention recognition result and the slot recognition result of the speech are respectively obtained based on the intention recognition branch and the slot recognition branch, and then the semantic recognition result of the speech to be progressed is generated based on the intention recognition result and the slot recognition result, thereby implementing the semantic recognition on the speech to be processed in combination with semantic information such as intention and slot of the speech to be progressed, and improving the accuracy of the semantic recognition.

With the method for semantic recognition according to embodiments of the disclosure, after the speech recognition result of the speech to be processed is obtained, the semantic vector of each historical object in the historical recognition result fragment is obtained, and the semantic vector of each newly added object is obtained by inputting the semantic vector of each historical object and each newly added object in the newly added recognition result fragment into the streaming semantic coding layer. The fusion semantic vector of each historical object and the fusion semantic vector of each newly added object are obtained by inputting the semantic vector of each historical object and the semantic vector of each newly added object into the streaming semantic vector fusion layer. The semantic recognition result of the speech to be progressed is obtained by inputting the fusion semantic vector of each historical object and the fusion semantic vector of each newly added object into the semantic understanding multi-task layer. In this way, real-time semantic recognition on the speech of the user is implemented, response time of the human-machine speech interaction system is shortened, interaction efficiency is improved, and user experience is enhanced.

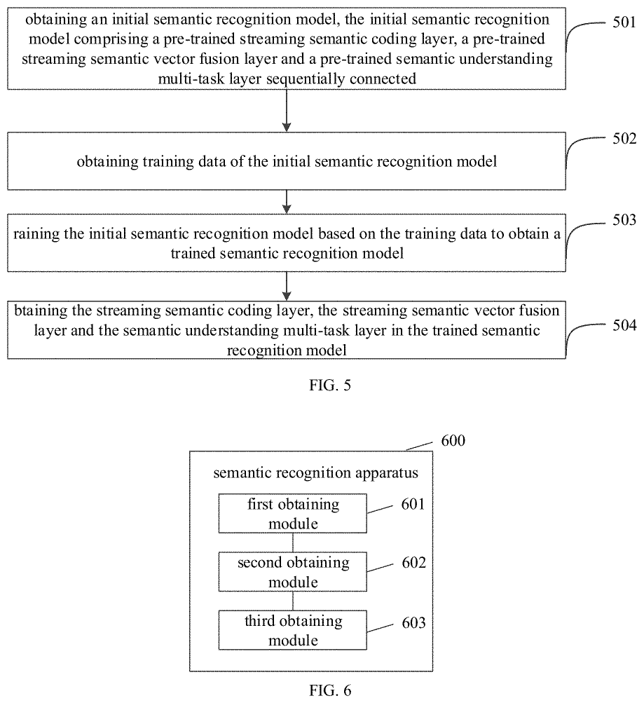

It may be known from the above analysis that, in embodiments of the disclosure, real-time semantic recognition may be implemented through a streaming semantic coding layer, a streaming semantic vector fusion layer and a semantic understanding multi-task layer. With reference to FIG. 5, description will be made below to the process of obtaining the streaming semantic coding layer, the streaming semantic vector fusion layer and the semantic understanding multi-task layer in the method for semantic recognition provided by the disclosure.

FIG. 5 is a flow chart illustrating a method for semantic recognition according to a fourth embodiment of the disclosure. As illustrated in FIG. 5, the method may also include the following blocks.

At block 501, an initial semantic recognition model is obtained. The initial semantic recognition model includes a pre-trained streaming semantic coding layer, a pre-trained streaming semantic vector fusion layer and a pre-trained semantic understanding multi-task layer sequentially connected.

At block 502, training data of the initial semantic recognition model is obtained.

At block 503, the initial semantic recognition model is trained based on the training data to obtain a trained semantic recognition model.

At block 504, the streaming semantic coding layer, the streaming semantic vector fusion layer and the semantic understanding multi-task layer in the trained semantic recognition model are obtained.

In embodiments of the disclosure, the initial semantic recognition model including the pre-trained streaming semantic coding layer, the pre-trained streaming semantic vector fusion layer and the pre-trained semantic understanding multi-task layer which are connected in sequence may be obtained. The training data of the semantic recognition model may be obtained. Then the initial semantic recognition model may be trained based on the training data to obtain the streaming semantic coding layer, the streaming semantic vector fusion layer and the semantic understanding multi-task layer for semantic recognition.

The streaming semantic coding layer may include a multi-layer coding layer of a transformer model. The coding layer includes a multi-head-attention mechanism with a mask. The streaming semantic vector fusion layer may be a unidirectional LSTM layer. The semantic understanding multi-task layer may include an intention recognition branch and a slot recognition branch.

The streaming semantic coding layer in the semantic recognition model may be the streaming semantic coding layer subjected to the pre-training.

In an embodiment, obtaining the pre-trained streaming semantic coding layer includes: obtaining an initial streaming semantic coding layer; obtaining pre-training data, the pre-training data including object series whose number of series is greater than a preset number; constructing a pre-training model based on the initial streaming semantic coding layer; and training the pre-training model based on the pre-training data to obtain the streaming semantic coding layer in the pre-training model.

The preset number may be set as requirements. It may be understood that, the larger the preset number, the more object series included in the pre-training data, and the higher the prediction accuracy of the streaming semantic coding layer in the pre-training model trained based on the pre-training data is. In a practical application, in order to improve the accuracy of the semantic recognition of the human-machine speech interaction system, the preset number may be set as a large value.

The object series is a series consist of objects, such as, a series consist of objects “uuuo”, “xiang”, and “ting”. A first series in the object series may be any object series in the object series.

The pre-training model may be formed according to a roberta model and an Electra model based on a transformer structure. Both the Electra model and the roberta model are based on the transformer structure, while a decoding part of the Electra model refers to the roberta model. The pre-training model may be trained in a way of deep learning. The detailed process of training the pre-training model may refer to the description in the related art, which is not elaborated here.

It may be understood that, presently, the speech of the user becomes more and more free and colloquial, and long-tail expressions become more and more abundant. In embodiments of the disclosure, the pre-training model based on the transformer structure may be trained based on large-scale unsupervised pre-training corpus to obtain the pre-trained streaming semantic coding layer. Comparing with the LSTM network and the RNN network, the transformer has better modeling ability for long-distance context. Therefore, obtaining the semantic vector of each object during semantic recognition is based on the pre-trained streaming semantic coding layer obtained by training the pre-training model, which may improve generalization of the semantic recognition model for the long tail expressions and redundant colloquial expressions and migration ability of the semantic recognition model in the apparatus for semantic recognition and improve accuracy of semantic understanding on the long tail expressions of the user and expressions including redundant colloquial.

In addition, it may be understood that, when the speech recognition result is in a unit of a syllable, the error accumulation caused by a recognition problem that pronunciation is right but a word is wrong may be obviously improved. However, there may introduce some fuzzy factors to a certain extent, such as a problem of homophones with different meanings. Such problem is required to combine with context to fully understand the semantics of the homophones.

However, the pre-trained streaming semantic coding layer based on the transformer structure employed in the disclosure has strong enough representation ability, and may obtain more sufficient and richer semantic representation by learning unsupervised pre-training data on a large scale, thereby improving an ambiguity problem of homophones with different meanings introduced when the speech recognition result takes the syllable as a unit.

In an embodiment, the initial semantic recognition model is trained to obtain the trained semantic recognition model, and the training data includes at least one of intention training data, slot training data and intention slot training data.

The intention training data is training data marked with an intention. The slot training data is training data marked with a slot position. The intention slot training data is training data marked with the intention and the slot position.

In an embodiment, the initial semantic recognition model may be trained based on the training data to obtain the trained semantic recognition model. Then, the streaming semantic coding layer, the streaming semantic vector fusion layer and the semantic understanding multi-task layer in the trained semantic recognition model are taken as the streaming semantic coding layer, the streaming semantic vector fusion layer and the semantic understanding multi-task layer for semantic recognition.

In an embodiment, the initial semantic recognition model may be trained based on training data in a way illustrated in following action at blocks 503a-503c.

At block 503a, the pre-trained streaming semantic coding layer, the pre-trained streaming semantic vector fusion layer and the pre-trained semantic understanding multi-task layer are trained based on the intention slot training data when the training data includes the intention training data, the slot training data and the intention slot training data.

At block 503b, intention recognition branches in the pre-trained streaming semantic coding layer, the pre-trained streaming semantic vector fusion layer and the pre-trained semantic understanding multi-task layer are trained based on the intention training data.

At block 503c, slot recognition branches in the pre-trained streaming semantic coding layer, the pre-trained streaming semantic vector fusion layer and the pre-trained semantic understanding multi-task layer are trained based on the slot training data.

In detail, when the training data includes the intention training data, the slot training data and the intention slot training data, the intention slot training data may be used to train the pre-trained streaming semantic coding layer, the pre-trained streaming semantic vector fusion layer and the pre-trained semantic understanding multi-task layer. At this time, parameters of the pre-trained streaming semantic coding layer, the pre-trained streaming semantic vector fusion layer and the pre-trained semantic understanding multi-task layer included in the whole semantic recognition model are all involved in training update. Then, the intention training data may be used to train the intention recognition branches respective in the pre-trained streaming semantic coding layer, he pre-trained streaming semantic vector fusion layer and he pre-trained semantic understanding multi-task layer, to update the parameters of the pre-trained streaming semantic coding layer and the pre-trained streaming semantic vector fusion layer, and to fine-tune the parameters of the intention recognition branch in the pre-trained semantic understanding multi-task layer. After that, the slot training data may be used to train the slot recognition branches respective in the pre-trained streaming semantic coding layer, the pre-trained streaming semantic vector fusion layer and the pre-trained semantic understanding multi-task layer, to update the parameters of the pre-trained streaming semantic coding layer and the pre-trained streaming semantic vector fusion layer, and to fine-tune the parameters of the slot recognition branch in the pre-trained semantic understanding multi-task layer.

It may be understood that, in a practical application scene, an obtaining cost of the slot training data is much higher than that of the intention training data. In a same way and a same time cost, such as, both the slot training data and the intention training data are obtained in the same time in a same way of manual marking or automatic mining. Therefore, the amount of high-quality intention training data obtained is much greater than the amount of high-quality slot training data obtained. Similarly, an obtaining cost of the intention slot training data is higher than that of the intention training data. Therefore, the amount of intention slot training data is far lower than the amount of the intention training data. The training effect may be poor in a case of training the semantic recognition model only based on the intention slot training data.

In embodiments of the disclosure, the semantic recognition model including the pre-trained streaming semantic coding layer, the pre-trained streaming semantic vector fusion layer and the pre-trained semantic understanding multi-task layer is trained based on the intention slot training data. The intention recognition branches of the pre-trained streaming semantic coding layer, the pre-trained streaming semantic vector fusion layer and the pre-trained semantic understanding multi-task layer are trained based on the intention training data. Then the slot recognition branches of the pre-trained streaming semantic coding layer, the pre-trained streaming semantic vector fusion layer and the pre-trained semantic understanding multi-task layer are trained based on the slot training data. Mixed training is performed on the semantic recognition model based on the intention slot training data, the intention training data and the slot training data, thereby improving the training effect of the semantic recognition model by making full use of a large scale of intention training data, a limited amount of slot training data and intention slot training data.

It should be noted that, in an embodiment, an execution order at blocks 503a, 503b and 503c may also be any other order, which is not limited by the disclosure

With the method for semantic recognition according to embodiments of the disclosure, after the initial semantic recognition model including the pre-trained streaming semantic coding layer, the pre-trained streaming semantic vector fusion layer and the pre-trained semantic understanding multi-task layer sequentially connected is obtained and the training data of the semantic recognition model is obtained, the initial semantic recognition model is trained based on the training data to obtain the trained semantic recognition model. Then, the streaming semantic coding layer, the streaming semantic vector fusion layer and the semantic understanding multi-task layer in the trained semantic recognition model are obtained. In this way, it is implemented that the trained streaming semantic coding layer, the trained streaming semantic vector fusion layer and the trained semantic understanding multi-task layer are obtained, such that real-time semantic recognition on the speech of the user may be performed in real time based on the trained streaming semantic coding layer, the trained streaming semantic vector fusion layer and the trained semantic understanding multi-task layer.

Description will be made blow to an apparatus for semantic recognition provided by the disclosure with reference to FIG. 6.

FIG. 6 is a block diagram illustrating an apparatus for semantic recognition according to a fifth embodiment of the disclosure.

As illustrated in FIG. 6, the apparatus for semantic recognition 600 provided by the disclosure includes: a first obtaining module 601, a second obtaining module 602, and a third obtaining module 603.

The first obtaining module 601 is configured to obtain a speech recognition result of a speech to be processed. The speech recognition result includes a newly added recognition result fragment and a historical recognition result fragment. The newly added recognition result fragment is a recognition result fragment corresponding to a newly added speech fragment in the speech.

The second obtaining module 602 is configured to obtain a semantic vector of each historical object in the historical recognition result fragment, and to obtain a semantic vector of each newly added object by inputting the semantic vector of each historical object and each newly added object in the newly added recognition result fragment into a streaming semantic coding layer.

The third obtaining module 60 is configured to obtain a semantic recognition result of the speech by inputting the semantic vector of each historical object and the semantic vector of each newly added object into a streaming semantic vector fusion layer and a semantic understanding multi-task layer sequentially arranged.

It should be noted that, the apparatus for semantic recognition provided by embodiments may be configured to execute the method for semantic recognition according to the above embodiments. The apparatus for semantic recognition may be an electronic device or may be configured in the electronic device to perform real-time semantic recognition on the speech of the user, thereby shortening the response time of the human-machine speech interaction system, improving the interaction efficiency and the user experience.

The electronic device may be any static or mobile computing device capable of performing data processing. The mobile computing device may be such as a notebook computer, a smart phone or a wearable device. The static computing device may be such as a desktop computer or a server. The apparatus for semantic recognition may be an electronic device, an application program installed in the electronic device for semantic recognition, or a web page or an application used by a manager or a developer of the application program capable of implementing the semantic recognition for managing and maintaining the application program, which is not limited by the disclosure.

It should be noted that, the above description for embodiments of the method for semantic recognition is also applicable to the apparatus for semantic recognition provided in the disclosure, which is not elaborated here.

With the apparatus for semantic recognition provided by embodiments of the disclosure, the speech recognition result of the speech to be processed is obtained. The semantic vector of each historical object in the historical recognition result fragment is obtained. The semantic vector of each newly added object is obtained by inputting the semantic vector of each historical object and each newly added object in the newly added recognition result fragment into the streaming semantic coding layer. The semantic recognition result of the speech is obtained by inputting the semantic vector of each historical object and the semantic vector of each newly added object into the streaming semantic vector fusion layer and the semantic understanding multi-task layer sequentially arranged. In this way, real-time semantic recognition on the speech of the user is implemented, the response time of the human-machine speech interaction system is shortened, interaction efficiency is improved, and the user experience is enhanced.

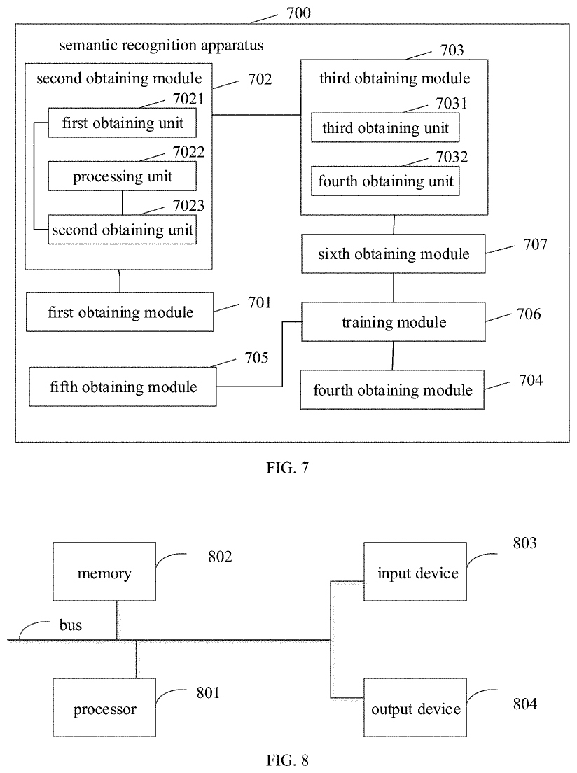

Description will be made blow to an apparatus for semantic recognition provided by the disclosure with reference to FIG. 7.

FIG. 7 is a block diagram illustrating an apparatus for semantic recognition according to a sixth embodiment of the disclosure.

As illustrated in FIG. 7, the apparatus for semantic recognition 700 may include: a first obtaining module 701, a second obtaining module 702, and a third obtaining module 703. The modules 701-703 in FIG. 7 have same functions as the modules 601-603 in FIG. 6.

In an exemplary embodiment, as illustrated in FIG. 7, the second obtaining module 702 may include: a first obtaining unit 7021, a processing unit 7022, and a second obtaining unit 7023.

The first obtaining unit 7021 is configured to, for each newly added object, obtain a splicing vector of the newly added object, the splicing vector being obtained by splicing an object vector and a position vector of the newly added object.

The processing unit 7022 is configured to perform initializing setting on an intermediate result of each historical object in the streaming semantic coding layer based on the semantic vector of each historical object to obtain a set streaming semantic coding layer.

The second obtaining unit 7023 is configured to obtain the semantic vector of the newly added object by inputting the splicing vector of each newly added object into the set streaming semantic coding layer.

In an exemplary embodiment, as illustrated in FIG. 7, the third obtaining module 703 may include: a third obtaining unit 7031 and a fourth obtaining unit 7032.

The third obtaining unit 7031 is configured to obtain a fusion semantic vector of each historical object an a fusion semantic vector of each newly added object by inputting the semantic vector of each historical object and the semantic vector of each newly added object into the streaming semantic vector fusion layer. The fusion semantic vector of the newly added object is obtained by performing semantic vector fusion on the newly added object and one or more previous objects.

The fourth obtaining unit 7032 is configured to obtain the semantic recognition result of the speech by inputting the fusion semantic vector of each historical object and the fusion semantic vector of each newly added object into the semantic understanding multi-task layer.

In an exemplary embodiment, the semantic understanding multi-task layer includes an intention recognition branch and a slot recognition branch. Correspondingly, the fourth obtaining unit may include: a first obtaining sub-unit, a second obtaining sub-unit, and a generating sub-unit.

The first obtaining sub-unit is configured to obtain an intention recognition result of the speech by inputting a fusion semantic vector of a first newly added object sorted last in respective newly added objects into the intention recognition branch.

The second obtaining sub-unit is configured to obtain a slot recognition result of the speech by inputting the fusion semantic vector of each historical object and the fusion semantic vector of each newly added object into the slot recognition branch.

The generating sub-unit is configured to generate the semantic recognition result of the speech based on the intention recognition result and the slot recognition result.

In an exemplary embodiment, as illustrated in FIG. 7, the apparatus for semantic recognition 700 may also include: a fourth obtaining module 704, a fifth obtaining module 705, a training module 706, and a sixth obtaining module 707.

The fourth obtaining module 704 is configured to obtain an initial semantic recognition model, the initial semantic recognition model comprising a pre-trained streaming semantic coding layer, a pre-trained streaming semantic vector fusion layer and a pre-trained semantic understanding multi-task layer sequentially connected.

The fifth obtaining module 705 is configured to obtain training data of the initial semantic recognition model.

The training module 706 is configured to train the initial semantic recognition model based on the training data to obtain a trained semantic recognition model.

The sixth obtaining module 707 is configured to obtain the streaming semantic coding layer, the streaming semantic vector fusion layer and the semantic understanding multi-task layer in the trained semantic recognition model.

In an exemplary embodiment, the training data includes at least one of intention training data, slot training data and intention slot training data. Correspondingly, the training module 706 may include: a first training unit, a second training unit, and a third training unit.

The first training unit is configured to train the pre-trained streaming semantic coding layer, the pre-trained streaming semantic vector fusion layer and the pre-trained semantic understanding multi-task layer based on the intention slot training data when the training data includes the intention training data, the slot training data and the intention slot training data.

The second training unit is configured to train intention recognition branches in the pre-trained streaming semantic coding layer, the pre-trained streaming semantic vector fusion layer and the pre-trained semantic understanding multi-task layer based on the intention training data.

The third training unit is configured to train slot recognition branches in the pre-trained streaming semantic coding layer, the pre-trained streaming semantic vector fusion layer and the pre-trained semantic understanding multi-task layer based on the slot training data.

In an exemplary embodiment, the fourth obtaining module 704 may include: a fifth obtaining unit, a sixth obtaining unit, a constructing unit, and a fourth training unit.

The fifth obtaining unit is configured to obtain an initial streaming semantic coding layer.

The sixth obtaining unit is configured to obtain pre-training data, the pre-training data comprising object series whose number of series is greater than a preset number.

The constructing unit is configured to construct a pre-training model based on the initial streaming semantic coding layer.

The fourth training unit is configured to train the pre-training model based on the pre-training data to obtain the streaming semantic coding layer in the pre-training model.

In an exemplary embodiment, the first obtaining module 701 may include: a seventh obtaining unit, configured to obtain a syllable recognition result of the speech by inputting the speech into a syllable recognition model; and determine the syllable recognition result as the speech recognition result of the speech.

In an exemplary embodiment, the streaming semantic coding layer includes a multi-layer coding layer of a translation transformer model. The streaming semantic coding layer includes a multi-head-attention mechanism with a mask. The streaming semantic vector fusion layer is a one-way long-short-term memory network LSTM layer

It should be noted that, the above description for embodiments of the method for semantic recognition is also applicable to the apparatus for semantic recognition provided in the disclosure, which is not elaborated here.

With the apparatus for semantic recognition provided by embodiments of the disclosure, the speech recognition result of the speech to be processed is obtained. The semantic vector of each historical object in the historical recognition result fragment is obtained. The semantic vector of each newly added object is obtained by inputting the semantic vector of each historical object and each newly added object in the newly added recognition result fragment into the streaming semantic coding layer. The semantic recognition result of the speech is obtained by inputting the semantic vector of each historical object and the semantic vector of each newly added object into the streaming semantic vector fusion layer and the semantic understanding multi-task layer sequentially arranged. In this way, real-time semantic recognition on the speech of the user is implemented, the response time of the human-machine speech interaction system is shortened, interaction efficiency is improved, and the user experience is enhanced.

According to embodiments of the disclosure, the disclosure also provides an electronic device and a readable storage medium.

As illustrated in FIG. 8, FIG. 8 is a block diagram illustrating an electronic device capable of implementing a method for semantic recognition according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components illustrated herein are merely examples, and are not intended to limit the implementation of the disclosure described and/or claimed herein.

As illustrated in FIG. 8, the electronic device includes: one or more processors 801, a memory 802, and interfaces for connecting various components, including a high-speed interface and a low-speed interface. Various components are connected to each other via different buses, and may be mounted on a common main board or in other ways as required. The processor may process instructions executed within the electronic device, including instructions stored in or on the memory to display graphical information of the GUI (graphical user interface) on an external input/output device (such as a display device coupled to an interface). In other implementations, multiple processors and/or multiple buses may be used together with multiple memories if desired. Similarly, multiple electronic devices may be connected, and each device provides some necessary operations (for example, as a server array, a group of blade servers, or a multiprocessor system). In FIG. 8, a processor 801 is taken as an example.

The memory 802 is a non-transitory computer readable storage medium provided by the disclosure. The memory is configured to store instructions executable by at least one processor, to enable the at least one processor to execute the method for semantic recognition provided by the disclosure. The non-transitory computer readable storage medium provided by the disclosure is configured to store computer instructions. The computer instructions are configured to enable a computer to execute the method for semantic recognition provided by the disclosure.

As the non-transitory computer readable storage medium, the memory 802 may be configured to store non-transitory software programs, non-transitory computer executable programs and modules, such as program instructions/module (such as the first obtaining module 601, the second obtaining module 602, and the third obtaining module 603 in FIG. 6) corresponding to the method for semantic recognition according to embodiments of the disclosure. The processor 801 is configured to execute various functional applications and data processing of the server by operating non-transitory software programs, instructions and modules stored in the memory 802, that is, implements the method for semantic recognition according to the above method embodiments.

The memory 802 may include a storage program region and a storage data region. The storage program region may store an application required by an operating system and at least one function. The storage data region may store data created according to prediction usage of the electronic device. In addition, the memory 802 may include a high-speed random accessing memory, and may also include a non-transitory memory, such as at least one disk memory device, a flash memory device, or other non-transitory solid-state memory device. In some embodiments, the memory 802 may optionally include memories remotely located to the processor 801, and these remote memories may be connected to the electronic device via a network. Examples of the above network include, but are not limited to, an Internet, an intranet, a local area network, a mobile communication network and combinations thereof.

The electronic device capable of implementing the method for semantic recognition may also include: an input device 803 and an output device 804. The processor 801, the memory 802, the input device 803, and the output device 804 may be connected via a bus or in other means. In FIG. 8, the bus is taken as an example.

The input device 803 may receive inputted digital or character information, and generate key signal input related to user setting and function control of the electronic device, such as a touch screen, a keypad, a mouse, a track pad, a touch pad, an indicator stick, one or more mouse buttons, a trackball, a joystick and other input device. The output device 804 may include a display device, an auxiliary lighting device (e.g., LED), a haptic feedback device (e.g., a vibration motor), and the like. The display device may include, but be not limited to, a liquid crystal display (LCD), a light emitting diode (LED) display, and a plasma display. In some embodiments, the display device may be the touch screen.

The various implementations of the system and technologies described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general purpose programmable processor, may receive data and instructions from a storage system, at least one input device, and at least one output device, and may transmit data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including a machine readable medium that receives machine instructions as a machine readable signal. The term “machine readable signal” refers to any signal for providing the machine instructions and/or data to the programmable processor.

To provide interaction with a user, the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), through which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser through which the user may interact with embodiments of the system and technologies described herein), or a computing system including any combination of such background component, the middleware components and the front-end component. Components of the system may be connected to each other via digital data communication in any form or medium (such as, a communication network). Examples of the communication network include a local area network (LAN), a wide area networks (WAN), and the Internet.

The computer system may include a client and a server. The client and the server are generally remote from each other and typically interact via the communication network. A client-server relationship is generated by computer programs operating on corresponding computers and having the client-server relationship with each other. The server may be a cloud server, also known as a cloud computing server or a cloud host. The server is a host product in a cloud computing service system, to solve defects of difficult management and weak business scalability in a conventional physical host and a VPS service (“virtual private server”). The server may also be a server of a distributed system or a server combined with a blockchain.

The disclosure relates to a field of artificial intelligence technologies and further to a field of deep learning and natural language processing technologies,

It should be noted that, artificial intelligence is a subject that studies the computer to simulate some thinking processes and intelligent behaviors of human beings (such as learning, reasoning, thinking, planning, etc.), and has both hardware and software technologies. Artificial intelligence hardware technologies generally include technologies such as a sensor, a special artificial intelligence chip, cloud computing, distributed storage, and big data processing. Artificial intelligence software technologies mainly include computer vision, speech recognition technologies, natural language processing technologies, machine learning/deep learning, big data processing technologies, knowledge map technologies and so on

With the technical solution according to embodiments of the disclosure, real-time semantic recognition on the speech of the user is implemented, the response time of the human-machine speech interaction system is shortened, interaction efficiency is improved, and the user experience is enhanced.

It should be understood that, steps may be reordered, added or deleted by utilizing flows in the various forms illustrated above. For example, the steps described in the disclosure may be executed in parallel, sequentially or in different orders, so long as desired results of the technical solution disclosed in the disclosure may be achieved, there is no limitation here. The above detailed implementations do not limit the protection scope of the disclosure. It should be understood by the skilled in the art that various modifications, combinations, sub-combinations and substitutions may be made based on design requirements and other factors. Any modification, equivalent substitution and improvement made within the principle of the disclosure shall be included in the protection scope of disclosure.

What is claimed is:

1. A method for semantic recognition, comprising:
obtaining a speech recognition result of a speech to be processed, wherein the speech recognition result comprises a newly added recognition result fragment and a historical recognition result fragment, and the newly added recognition result fragment is a recognition result fragment corresponding to a newly added speech fragment in the speech;
obtaining a semantic vector of each historical object in the historical recognition result fragment, and obtaining a semantic vector of each newly added object by inputting the semantic vector of each historical object and each newly added object in the newly added recognition result fragment into a streaming semantic coding layer; and
obtaining a semantic recognition result of the speech by inputting the semantic vector of each historical object and the semantic vector of each newly added object into a streaming semantic vector fusion layer and a semantic understanding multi-task layer sequentially arranged.

2. The method of claim 1, wherein obtaining the semantic vector of each newly added object by inputting the semantic vector of each historical object and each newly added object in the newly added recognition result fragment into the streaming semantic coding layer comprises:
for each newly added object, obtaining a splicing vector of the newly added object, the splicing vector being obtained by splicing an object vector and a position vector of the newly added object;
performing initializing setting on an intermediate result of each historical object in the streaming semantic coding layer based on the semantic vector of each historical object to obtain a set streaming semantic coding layer; and
obtaining the semantic vector of the newly added object by inputting the splicing vector of each newly added object into the set streaming semantic coding layer.

3. The method of claim 1, wherein obtaining the semantic recognition result of the speech by inputting the semantic vector of each historical object and the semantic vector of each newly added object into the streaming semantic vector fusion layer and the semantic understanding multi-task layer sequentially arranged comprises:
obtaining a fusion semantic vector of each historical object and a fusion semantic vector of each newly added object by inputting the semantic vector of each historical object and the semantic vector of each newly added object into the streaming semantic vector fusion layer, the fusion semantic vector of the newly added object being obtained by performing semantic vector fusion on the newly added object and one or more previous objects; and
obtaining the semantic recognition result of the speech by inputting the fusion semantic vector of each historical object and the fusion semantic vector of each newly added object into the semantic understanding multi-task layer.

4. The method of claim 3, wherein the semantic understanding multi-task layer comprises an intention recognition branch and a slot recognition branch; and
wherein obtaining the semantic recognition result of the speech by inputting the fusion semantic vector of each historical object and the fusion semantic vector of each newly added object into the semantic understanding multi-task layer comprises:
obtaining an intention recognition result of the speech by inputting a fusion semantic vector of a first newly added object sorted last in respective newly added objects into the intention recognition branch;
obtaining a slot recognition result of the speech by inputting the fusion semantic vector of each historical object and the fusion semantic vector of each newly added object into the slot recognition branch; and
generating the semantic recognition result of the speech based on the intention recognition result and the slot recognition result.

5. The method of claim 1, before obtaining the semantic vector of each newly added object by inputting the semantic vector of each historical object and each newly added object in the newly added recognition result fragment into the streaming semantic coding layer, further comprising:
obtaining an initial semantic recognition model, the initial semantic recognition model comprising a pre-trained streaming semantic coding layer, a pre-trained streaming semantic vector fusion layer and a pre-trained semantic understanding multi-task layer sequentially connected;
obtaining training data of the initial semantic recognition model;
training the initial semantic recognition model based on the training data to obtain a trained semantic recognition model; and
obtaining the streaming semantic coding layer, the streaming semantic vector fusion layer and the semantic understanding multi-task layer in the trained semantic recognition model.

6. The method of claim 5, wherein the training data comprises at least one of intention training data, slot training data and intention slot training data;
wherein training the initial semantic recognition model based on the training data to obtain the trained semantic recognition model comprises:
when the training data comprises the intention training data, the slot training data and the intention slot training data, training the pre-trained streaming semantic coding layer, the pre-trained streaming semantic vector fusion layer and the pre-trained semantic understanding multi-task layer based on the intention slot training data;
training intention recognition branches in the pre-trained streaming semantic coding layer, the pre-trained streaming semantic vector fusion layer and the pre-trained semantic understanding multi-task layer based on the intention training data; and
training slot recognition branches in the pre-trained streaming semantic coding layer, the pre-trained streaming semantic vector fusion layer and the pre-trained semantic understanding multi-task layer based on the slot training data.

7. The method of claim 5, wherein obtaining the pre-trained streaming semantic coding layer comprises:
obtaining an initial streaming semantic coding layer;
obtaining pre-training data, the pre-training data comprising object series whose number of series is greater than a preset number;
constructing a pre-training model based on the initial streaming semantic coding layer; and
training the pre-training model based on the pre-training data to obtain the streaming semantic coding layer in the pre-training model.

8. The method of claim 1, wherein obtaining the speech recognition result of the speech comprises:
obtaining a syllable recognition result of the speech by inputting the speech into a syllable recognition model; and
determining the syllable recognition result as the speech recognition result of the speech.

9. The method of claim 1, wherein the streaming semantic coding layer comprises a multi-layer coding layer of a translation transformer model, the streaming semantic coding layer comprises a multi-head-attention mechanism with a mask; and the streaming semantic vector fusion layer is a one-way long-short-term memory network LSTM layer.

10. An electronic device, comprising:
at least one processor; and
a memory, communicatively coupled to the at least one processor,
wherein the memory is configured to store instructions executable by the at least one processor, and when the instructions are executed by the at least one processor, the at least one processor is configured to:
obtain a speech recognition result of a speech to be processed, wherein the speech recognition result comprises a newly added recognition result fragment and a historical recognition result fragment, and the newly added recognition result fragment is a recognition result fragment corresponding to a newly added speech fragment in the speech;
obtain a semantic vector of each historical object in the historical recognition result fragment, and to obtain a semantic vector of each newly added object by inputting the semantic vector of each historical object and each newly added object in the newly added recognition result fragment into a streaming semantic coding layer; and
obtain a semantic recognition result of the speech by inputting the semantic vector of each historical object and the semantic vector of each newly added object into a streaming semantic vector fusion layer and a semantic understanding multi-task layer sequentially arranged.

11. The electronic device of claim 10, wherein the at least one processor is configured to:
a first obtaining unit, configured to, for each newly added object, obtain a splicing vector of the newly added object, the splicing vector being obtained by splicing an object vector and a position vector of the newly added object;
a processing unit, configured to perform initializing setting on an intermediate result of each historical object in the streaming semantic coding layer based on the semantic vector of each historical object to obtain a set streaming semantic coding layer; and
a second obtaining unit, configured to obtain the semantic vector of the newly added object by inputting the splicing vector of each newly added object into the set streaming semantic coding layer.

12. The electronic device of claim 10, wherein the at least one processor is configured to:
a third obtaining unit, configured to obtain a fusion semantic vector of each historical object an a fusion semantic vector of each newly added object by inputting the semantic vector of each historical object and the semantic vector of each newly added object into the streaming semantic vector fusion layer, the fusion semantic vector of the newly added object being obtained by performing semantic vector fusion on the newly added object and one or more previous objects; and
a fourth obtaining unit, configured to obtain the semantic recognition result of the speech by inputting the fusion semantic vector of each historical object and the fusion semantic vector of each newly added object into the semantic understanding multi-task layer.

13. The electronic device of claim 12, wherein the semantic understanding multi-task layer comprises an intention recognition branch and a slot recognition branch; and
wherein the at least one processor is configured to:
a first obtaining sub-unit, configured to obtain an intention recognition result of the speech by inputting a fusion semantic vector of a first newly added object sorted last in respective newly added objects into the intention recognition branch;
a second obtaining sub-unit, configured to obtain a slot recognition result of the speech by inputting the fusion semantic vector of each historical object and the fusion semantic vector of each newly added object into the slot recognition branch; and
a generating sub-unit, configured to generate the semantic recognition result of the speech based on the intention recognition result and the slot recognition result.

14. The electronic device of claim 10, wherein the at least one processor is configured to:
obtain an initial semantic recognition model, the initial semantic recognition model comprising a pre-trained streaming semantic coding layer, a pre-trained streaming semantic vector fusion layer and a pre-trained semantic understanding multi-task layer sequentially connected;
obtain training data of the initial semantic recognition model;
train the initial semantic recognition model based on the training data to obtain a trained semantic recognition model; and
obtain the streaming semantic coding layer, the streaming semantic vector fusion layer and the semantic understanding multi-task layer in the trained semantic recognition model.

15. The electronic device of claim 14, the training data comprises at least one of intention training data, slot training data and intention slot training data;
wherein the at least one processor is configured to:
train the pre-trained streaming semantic coding layer, the pre-trained streaming semantic vector fusion layer and the pre-trained semantic understanding multi-task layer based on the intention slot training data when the training data comprises the intention training data, the slot training data and the intention slot training data;
train intention recognition branches in the pre-trained streaming semantic coding layer, the pre-trained streaming semantic vector fusion layer and the pre-trained semantic understanding multi-task layer based on the intention training data; and
train slot recognition branches in the pre-trained streaming semantic coding layer, the pre-trained streaming semantic vector fusion layer and the pre-trained semantic understanding multi-task layer based on the slot training data.

16. The electronic device of claim 14, wherein the at least one processor is configured to:
obtain an initial streaming semantic coding layer;
obtain pre-training data, the pre-training data comprising object series whose number of series is greater than a preset number;
construct a pre-training model based on the initial streaming semantic coding layer; and
train the pre-training model based on the pre-training data to obtain the streaming semantic coding layer in the pre-training model.

17. The electronic device of claim 10, wherein the at least one processor is configured to:
obtain a syllable recognition result of the speech by inputting the speech into a syllable recognition model; and determine the syllable recognition result as the speech recognition result of the speech.

18. The electronic device of claim 10, wherein the streaming semantic coding layer comprises a multi-layer coding layer of a translation transformer model, the streaming semantic coding layer comprises a multi-head-attention mechanism with a mask; and the streaming semantic vector fusion layer is a one-way long-short-term memory network LSTM layer.

19. A non-transitory computer readable storage medium having computer instructions stored thereon, wherein the computer instructions are configured to cause a computer to execute a method for semantic recognition, and the method comprises:
obtaining a speech recognition result of a speech to be processed, wherein the speech recognition result comprises a newly added recognition result fragment and a historical recognition result fragment, and the newly added recognition result fragment is a recognition result fragment corresponding to a newly added speech fragment in the speech;
obtaining a semantic vector of each historical object in the historical recognition result fragment, and obtaining a semantic vector of each newly added object by inputting the semantic vector of each historical object and each newly added object in the newly added recognition result fragment into a streaming semantic coding layer; and
obtaining a semantic recognition result of the speech by inputting the semantic vector of each historical object and the semantic vector of each newly added object into a streaming semantic vector fusion layer and a semantic understanding multi-task layer sequentially arranged.

20. The storage medium of claim 19, wherein obtaining the semantic vector of each newly added object by inputting the semantic vector of each historical object and each newly added object in the newly added recognition result fragment into the streaming semantic coding layer comprises:
for each newly added object, obtaining a splicing vector of the newly added object, the splicing vector being obtained by splicing an object vector and a position vector of the newly added object;
performing initializing setting on an intermediate result of each historical object in the streaming semantic coding layer based on the semantic vector of each historical object to obtain a set streaming semantic coding layer; and
obtaining the semantic vector of the newly added object by inputting the splicing vector of each newly added object into the set streaming semantic coding layer.
